(19) United States
(12) Patent Application Publication
(10) Pub. No.: US 2014/0350279 A1
(43) Pub. Date: Nov. 27, 2014

(54) METHOD FOR PREPARING METHYLCHLOROSILANES

(71) Applicant: Wacker Chemie AG, Muenchen (DE)

(72) Inventors: Anne ALBER, Muenchen (DE); Jan KUNERT, Seeheim (DE)

(73) Assignee: Wacker Chemie AG, Muenchen (DE)

(21) Appl. No.: 14/282,507

(22) Filed: May 20, 2014

(30) Foreign Application Priority Data
May 23, 2013 (DE) 10 2013 209 604.6

(51) Int. Cl. C07F 7/16

(52) U.S. Cl. CPC C07F 7/16
USPC 556/472

(57) ABSTRACT

The invention relates to a method for the direct synthesis of methylchlorosilanes by reacting chloromethane with a contact mass containing silicon, copper catalyst and at least 120 ppm by weight of manganese.

### BACKGROUND OF THE INVENTION

The invention relates to a method for the direct synthesis of methylchlorosilanes using manganese promoters.

In the direct synthesis of methylchlorosilanes according to the Müller Rochow process, metallic silicon is reacted with chloromethane in the presence of various catalysts and optionally promoters, in which the target product is dimethyldichlorosilane. The mixture of silicon, catalysts and optionally promoters is referred to as a catalyst composition.

Currently, 2,000,000 tons of dimethyldichlorosilane are produced annually worldwide, which means that small improvements in the production process, for example, increasing the dimethyldichlorosilane selectivity, thereby have a large economic impact.

Metallurgical silicon is used for preparing methylchlorosilanes. The latter has a purity of ca. 95-99%. The remainder is collectively composed of extraneous elements which pass either from the quartz raw materials and hydrocarbon source or from the production process (e.g. from slag constituents) into the silicon. These extraneous elements may be present in varying form, either as inclusions, as intermetallic phases with silicon or randomly distributed doped into silicon. Various effects on the Müller-Rochow process by these elements are known, either promoting, neutral or as poisons. Depending on the type of presence, the same element can also have different effects. For this reason, it is very complex to establish a clear link between the reaction course and the concentration of a particular element. The influences are usually only known empirically and not the precise mechanism of the effect.

Elements for which a promoting effect on the methylchlorosilane synthesis is known are: Zn, Sn, P, Sb, Al, Sr, Ag, Au, B, Se, Te, alkali metals and alkaline earth metals, V, Cd, In.

An increase in the dimethyldichlorosilane selectivity, for example, is described in DE102004046181A1 by Sr, in U.S. Pat. No. 6,407,276A by Au or Ag, in U.S. Pat. No. 6,339,167A by Al, in DE 4412837A by V and in EP671402A by Sb.

A promoting effect of manganese on the synthesis of methylchlorosilane has not been described in the literature to date. In the synthesis of trichlorosilane, a negative effect of manganese on the trichlorosilane selectivity and reactivity has been described. WO2006/031120A1, for example, describes a method for preparing trichlorosilane by reacting Si with HCl gas, in which the Si supplied to the reactor comprises less than 100 ppm of Mn.

### DESCRIPTION OF THE INVENTION

The invention relates to a method for the direct synthesis of methylchlorosilanes by reacting chloromethane with a catalyst composition comprising silicon, copper catalyst and at least 120 ppm by weight of manganese.

It has been found that an increased concentration of manganese in the catalyst composition in the reactor has a positive influence on the selectivity for the main product dimethyldichlorosilane. At concentrations of at least 120 ppm by weight of manganese, a dimethyldichlorosilane selectivity is attained which is around ca. 2% higher than the lower concentrations used to date.

The increased Mn concentration in the catalyst composition can originate from the raw materials, particularly the quartz, can be alloyed into the silicon or may be added to the catalyst composition in the form of an Mn compound, e.g. as a manganese salt such as MnCl₂, MnS, or as a manganese-silicon alloy. The increased Mn concentration does not have to be present in the silicon but may also arise in the reactor, in particular the fluidized bed reactor, by enrichment effects.

The Mn concentration in the catalyst composition is preferably 200-5000 ppm by weight, particularly preferably 300-600 ppm by weight of Mn.

The silicon used in the method preferably comprises at most 5% by weight, particularly preferably at most 2% by weight, particularly at most 1% by weight of other elements as impurities. The impurities, which account for at least 0.01% by weight, are preferably elements selected from Fe, Ni, Al, Ca, Cu, Zn, Sn, C, V, Ti, Cr, B, P, O.

The silicon particle size is preferably at least 0.5 micrometers, particularly preferably at least 5 micrometers, in particular at least 10 micrometers and preferably at most 650 micrometers, particularly preferably at most 580 micrometers, in particular at most 500 micrometers. The mean particle size distribution of the silicon is the d50 value and is preferably at least 180 micrometers, particularly preferably at least 200 micrometers, in particular at least 230 micrometers and preferably at most 350 micrometers, particularly preferably at most 300 micrometers, in particular at most 270 micrometers.

The copper for the catalyst may be selected from metallic copper, a copper alloy or a copper compound. The copper compound is preferably selected from copper oxide and copper chloride, particularly CuO, Cu₂O and CuCl or a copper-phosphorus compound (CuP alloy). Copper oxide may be, for example, copper in the form of copper oxide mixtures and in the form of copper(II) oxide. Copper chloride may be used in the form of CuCl or in the form of CuCl₂, although corresponding mixtures are also possible. In a preferred embodiment, the copper is used as CuCl.

Preference is given to using at least 0.1 part by weight, particularly preferably at least 1 part by weight of copper catalyst and preferably at most 10 parts by weight, particularly at most 8 parts by weight of copper catalyst to 100 parts by weight of silicon, based in each case on metallic copper.

The catalyst composition preferably comprises a zinc promoter which is preferably selected from zinc oxide and zinc chloride. Preference is given to using at least 0.01 part by weight of zinc promoter, particularly preferably at least 0.1 part by weight of zinc promoter and preferably at most 1 part by weight, particularly at most 0.5 part by weight of zinc promoter to 100 parts by weight of silicon, based in each case on metallic zinc.

The catalyst composition preferably comprises a tin promoter which is preferably selected from tin oxide and tin chloride. Preference is given to using at least 0.001 part by weight of tin promoter, particularly preferably at least 0.05 part by weight of tin promoter and preferably at most 0.2 part by weight, particularly at most 0.1 part by weight of tin promoter to 100 parts by weight of silicon, based in each case on metallic tin.

The catalyst composition preferably comprises a combination of zinc promoter and tin promoter and particularly also phosphorus promoter.

Preferably at least 50% by weight, particularly at least 80% by weight of the sum of copper catalyst and promoters are chlorides of copper, zinc and tin.

Besides the manganese promoters and optionally zinc and/or tin promoters, further promoters may also be used, which are preferably selected from the elements phosphorus, cesium, barium, iron and antimony and compounds thereof. The P promoter is preferably selected from CuP alloys.

The reaction is preferably conducted at at least 200° C., particularly preferably at least 250° C., particularly at least 300° C. and preferably at at most 450° C., particularly preferably at most 400° C.

The reaction pressure is preferably at least 1 bar, particularly at least 1.5 bar and preferably at most 5 bar, particularly at most 3 bar, stated in each case as absolute pressure.

The methylchlorosilanes prepared are particularly dimethyldichlorosilane, methyltrichlorosilane and trimethylchlorosilane and H-silanes.

The method may be carried out batchwise or preferably continuously. Continuously means that the reacted silicon and catalysts and promoters optionally discharged together with the reaction dust are continually replenished, preferably as a premixed catalyst composition. The continuous direct synthesis is preferably carried out in a fluidized bed reactor, in which chloromethane is preferably used simultaneously as reactant and fluidizing medium.

In the following examples, unless otherwise stated in each case, all amounts and percentages are based on weight, all pressures are 0.10 MPa (abs.) and all temperatures are 20° C.

### EXAMPLE 1

10 samples with different Mn concentrations were investigated in a laboratory reactor. The Mn was doped into silicon during the production process. Catalyst compositions from these 10 samples were investigated with otherwise identical catalyst addition consisting of the elements Cu, Zn, Sn, P using chloromethane in the laboratory reactor (volume flow rate=100 mL/min).

In each case, 15 g of the catalyst composition were treated with methyl chloride at 310° C. The analysis was performed by online GC. The selectivity for the main product dimethyldichlorosilane was calculated as follows:

$${S}_{M 2} = \frac{2 \times ( {n}_{M 2} - {n}_{M 2}^{0} )}{{n}_{MeCl}^{0} - {n}_{MeCl}}$$

The sample with the lowest Mn content (96 ppm, non-inventive) showed a distinctly poorer dimethyldichlorosilane selectivity (88.4%) than the other samples with higher Mn content, which all showed over 91% dimethyldichlorosilane selectivity. The results are listed in Table 1:

TABLE 1

| Mn content | Dimethyldichlorosilane selectivity |
|---|---|
| 96 ppm by weight* | 88.4% |
| 269 ppm by weight | 92.5% |
| 582 ppm by weight | 92.5% |
| 750 ppm by weight | 92.0% |
| 1193 ppm by weight | 94.0% |
| 1443 ppm by weight | 92.8% |
| 2060 ppm by weight | 93.0% |
| 3011 ppm by weight | 91.2% |
| 3955 ppm by weight | 92.8% |
| 4962 ppm by weight | 94.5% |

*non-inventive

### EXAMPLE 2

Experimental series with 3 samples were investigated with Mn contents of 96, 269 and 582 ppm manganese in the laboratory reactor. The performance of the individual experiments was analogous to that in Example 1. The catalyst compositions were subjected beforehand to a thermal pretreatment in order to homogenize the catalyst distribution and to shorten the induction phase. The sample with 96 ppm Mn showed an on average around 2% poorer dimethyldichlorosilane selectivity than the other two samples. The results are listed in Table 2:

TABLE 2

| Mn content | Dimethyldichlorosilane selectivity |
|---|---|
| 96 ppm by weight* | 89.7% |
| 269 ppm by weight | 91.6% |
| 582 ppm by weight | 91.8% |

*non-inventive

### EXAMPLE 3

In a laboratory fluidized bed reactor, catalyst composition samples with increased Mn concentrations up to ca. 400 ppm were investigated. In these samples, the increased Mn content came from the quartz raw material. All samples showed a very good activity and selectivity for dimethyldichlorosilane. The results are listed in Table 3:

TABLE 3

| Mn content | Dimethyldichlorosilane selectivity |
|---|---|
| 135 ppm by weight | 93% |
| 270 ppm by weight | 93% |
| 396 ppm by weight | 93% |
| 427 ppm by weight | 92.6% |

1. A method for a direct synthesis of methylchlorosilanes, said method comprising reacting chloromethane with a contact mass comprising silicon, a copper catalyst and at least 120 ppm by weight of manganese.

2. The method as claimed in claim 1, wherein the contact mass further comprises a zinc promoter.

3. The method as claimed in claim 1, wherein the contact mass further comprises a tin promoter.

4. The method as claimed in claim 3, wherein the contact mass further comprises a zinc promoter.

5. The method as claimed in claim 1, wherein the contact mass further comprises at least one promoter selected from the group consisting of phosphorus, cesium, barium, iron, antimony and compounds thereof.

6. The method as claimed in claim 2, wherein the contact mass further comprises at least one additional promoter selected from the group consisting of phosphorus, cesium, barium, iron, antimony and compounds thereof.

7. The method as claimed in claim 6, wherein the contact mass further comprises a tin promoter.

8. The method as claimed in claim 3, wherein the contact mass further comprises at least one additional promoter selected from the group consisting of phosphorus, cesium, barium, iron, antimony and compounds thereof.

9. The method as claimed in claim 1, wherein 0.1 to 10 parts by weight of the copper catalyst are used to 100 parts by weight of silicon, based on metallic copper.

10. The method as claimed in claim 2, wherein 0.1 to 10 parts by weight of the copper catalyst are used to 100 parts by weight of silicon, based on metallic copper.

11. The method as claimed in claim 3, wherein 0.1 to 10 parts by weight of the copper catalyst are used to 100 parts by weight of silicon, based on metallic copper.

12. The method as claimed in claim 4, wherein 0.1 to 10 parts by weight of the copper catalyst are used to 100 parts by weight of silicon, based on metallic copper.

13. The method as claimed in claim 5, wherein 0.1 to 10 parts by weight of the copper catalyst are used to 100 parts by weight of silicon, based on metallic copper.

14. The method as claimed in claim 6, wherein 0.1 to 10 parts by weight of the copper catalyst are used to 100 parts by weight of silicon, based on metallic copper.

15. The method as claimed in claim 7, wherein 0.1 to 10 parts by weight of the copper catalyst are used to 100 parts by weight of silicon, based on metallic copper.

16. The method as claimed in claim 8, wherein 0.1 to 10 parts by weight of the copper catalyst are used to 100 parts by weight of silicon, based on metallic copper.
